(19) United States
(12) Patent Application Publication
(10) Pub. No.: US 2007/0025438 A1
(43) Pub. Date: Feb. 1, 2007

(54) Elastic storage

(75) Inventor: Wilhelmus Hendrikus Alfonsus Bruls, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,389

(22) PCT Filed: Dec. 18, 2003
(86) PCT No.: PCT/IB03/06114

§ 371 Date: Jun. 15, 2005

(30) Foreign Application Priority Data
Dec. 20, 2002 (EP) 02080634.5

(51) Int. Cl. H04B 1/66; H04N 11/04; H04N 7/12

(52) U.S. Cl. 375/240.1; 375/240.2; 375/240.26

(57) ABSTRACT

A method and apparatus for providing elastic storage of layered video data stored in a storage apparatus are disclosed. The stored enhancement layer video data is read out of the storage apparatus. The enhancement layer video data is then at least partially decoded or ultimately completely deleted. The decoded enhancement layer video data is attenuated in a linear or non-linear manner. The attenuated enhancement layer video data is then encoded. The encoded attenuated video data is stored back in the storage apparatus.

### FIELD OF THE INVENTION

The invention relates to the storage of video content.

### BACKGROUND OF THE INVENTION

Many video applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image. With spatial scalability, the base layer video may have a lower resolution than the input video sequence, in which case the enhancement layer carries information which can restore the resolution of the base layer to the input sequence level.

Typically, these scaled video streams are stored together in a storage device by the content provider or service provider, so the quality level of the stored video content is fixed by the processing which was performed prior to storing the content. A user can access the storage device or the storage device can download the scaled video streams for display at a user device. However, storage problems may occur in the storage device. For example, a user may want to record a new video stream but there may not be enough room in the storage device to store the new video stream. In such situations, there is a need for elastic storage. The invention allows an effective way of reducing the bitrate, while little resources are needed to perform the operation.

### SUMMARY OF THE INVENTION

The invention overcomes at least part of the deficiencies described above by providing a method and apparatus for providing elastic storage by reading an enhancement layer out of a storage device and attenuating the enhancement layer to thereby lower the bit-rate of the enhancement layer, thus creating more space in the storage device.

According to one embodiment of the invention, a method and apparatus for providing elastic storage of layered video data stored in a storage apparatus are disclosed. The stored enhancement layer video data is read out of the storage apparatus. The enhancement layer video data is then at least partially decoded or ultimately completely deleted. The decoded enhancement layer video data is attenuated in a linear or non-linear manner. The attenuated enhancement layer video data is then encoded. The encoded attenuated video data is stored back in the storage apparatus.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a video compression system according to one embodiment of the invention;

FIG. 2 is a block diagram of a video compression system according to one embodiment of the invention;

FIG. 3 is a block diagram of a video encoder according to one embodiment of the invention; and

FIG. 4 is a block diagram of a video compression system according to one embodiment of the invention.

### DETAILED DESCRIPTION OF THE INVENTION

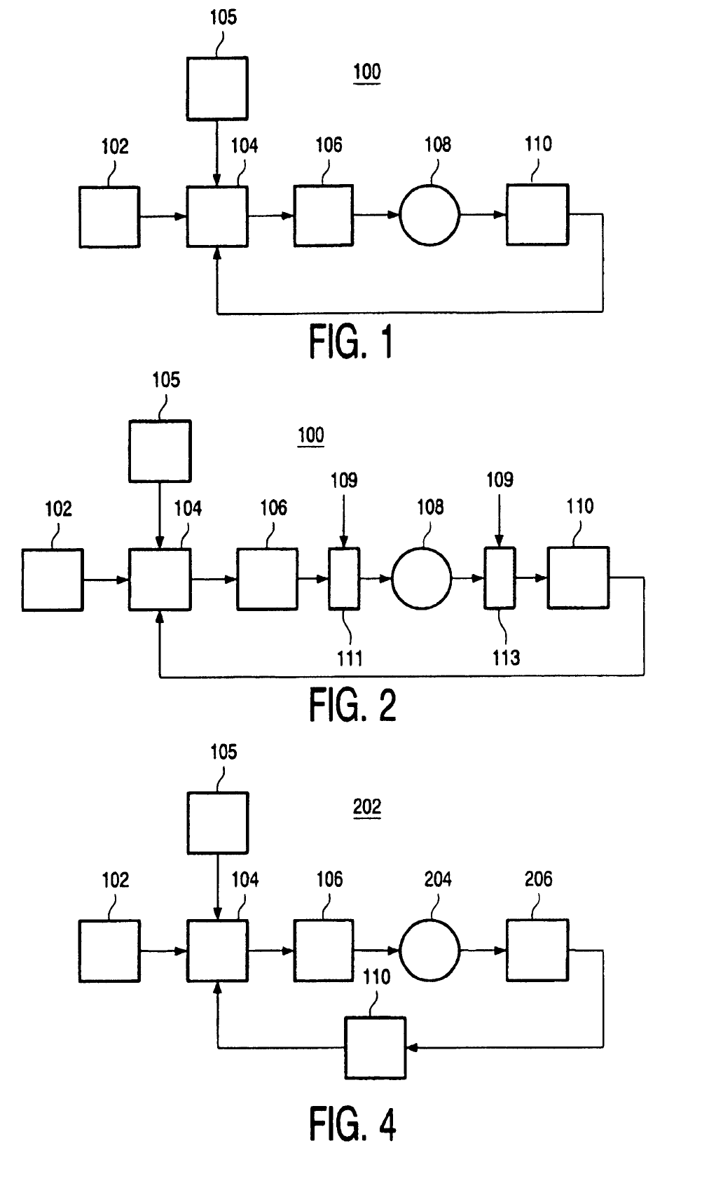

FIG. 1 illustrates a video compression and storage system 100 according to one embodiment of the invention. The video compression and storage system 100 comprises, among other features, a layered encoder 102, a storage apparatus 104, a control system 105, a variable length decoder 106, an attenuator 108 and a variable length coder 110.

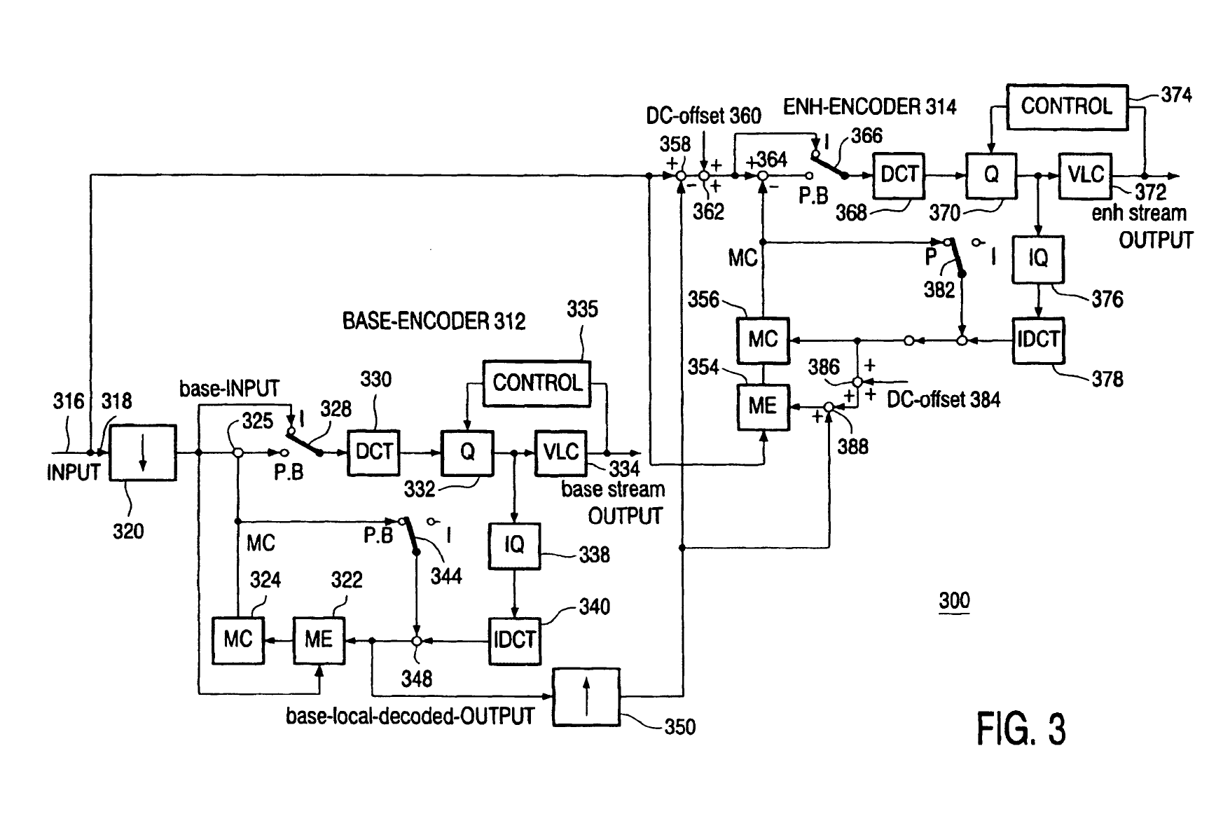

An illustrative example of a layered encoder is illustrated in FIG. 3, but it will be understood that other layered encoders can also be used by the invention and the invention is not limited thereto. The depicted encoding system 300 accomplishes layered compression, whereby a portion of the channel is used for providing a low resolution base layer and the remaining portion is used for transmitting edge enhancement information, whereby the two signals may be recombined to bring the system up to high resolution.

The encoder 300 comprises a base encoder 312 and an enhancement encoder 314. The base encoder is comprised of a low pass filter and downsampler 320, a motion estimator 322, a motion compensator 324, an orthogonal transform (e.g., Discrete Cosine Transform (DCT)) circuit 330, a quantizer 332, a variable length coder (VLC) 334, a bitrate control circuit 335, an inverse quantizer 338, an inverse transform circuit 340, switches 328, 344, and an interpolate and upsample circuit 350.

An input video block 316 is split by a splitter 318 and sent to both the base encoder 312 and the enhancement encoder 314. In the base encoder 312, the input block is inputted into a low pass filter and downsampler 320. The low pass filter reduces the resolution of the video block which is then fed to the motion estimator 322. The motion estimator 322 processes picture data of each frame as an I-picture, a P-picture, or as a B-picture. Each of the pictures of the sequentially entered frames is processed as one of the I-, P-, or B-pictures in a pre-set manner, such as in the sequence of I, B, P, B, P, . . . , B, P. That is, the motion estimator 322 refers to a pre-set reference frame in a series of pictures stored in a frame memory not illustrated and detects the motion vector of a macro-block, that is, a small block of 16 pixels by 16 lines of the frame being encoded by pattern matching (block Matching) between the macro-block and the reference frame for detecting the motion vector of the macro-block.

In MPEG, there are four picture prediction modes, that is an intra-coding (intra-frame coding), a forward predictive coding, a backward predictive coding, and a bi-directional predictive-coding. An I-picture is an intra-coded picture, a P-picture is an intra-coded or forward predictive coded or backward predictive coded picture, and a B-picture is an intra-coded, a forward predictive coded, or a bi-directional predictive-coded picture.

The motion estimator 322 performs forward prediction on a P-picture to detect its motion vector. Additionally, the motion estimator 322 performs forward prediction, backward prediction, and bi-directional prediction for a B-picture to detect the respective motion vectors. In a known manner, the motion estimator 322 searches, in the frame memory, for a block of pixels which most resembles the current input block of pixels. Various search algorithms are known in the art. They are generally based on evaluating the mean absolute difference (MAD) or the mean square error (MSE) between the pixels of the current input block and those of the candidate block. The candidate block having the least MAD or MSE is then selected to be the motion-compensated prediction block. Its relative location with respect to the location of the current input block is the motion vector.

Upon receiving the prediction mode and the motion vector from the motion estimator 322, the motion compensator 324 may read out encoded and already locally decoded picture data stored in the frame memory in accordance with the prediction mode and the motion vector and may supply the read-out data as a prediction picture to arithmetic unit 325 and switch 344. The arithmetic unit 325 also receives the input block and calculates the difference between the input block and the prediction picture from the motion compensator 324. The difference value is then supplied to the DCT circuit 330.

If only the prediction mode is received from the motion estimator 322, that is, if the prediction mode is the intra-coding mode, the motion compensator 324 may not output a prediction picture. In such a situation, the arithmetic unit 325 may not perform the above-description processing, but instead may directly output the input block to the DCT circuit 330.

The DCT circuit 330 performs DCT processing on the output signal from the arithmetic unit 33 so as to obtain DCT coefficients which are supplied to a quantizer 332. The quantizer 332 sets a quantization step (quantization scale) in accordance with the data storage quantity in a buffer (not illustrated) received as a feedback and quantizes the DCT coefficients from the DCT circuit 330 using the quantization step. The quantized DCT coefficients are supplied to the VLC unit 334 along with the set quantization step.

The VLC unit 334 converts the quantization coefficients supplied from the quantizer 332 into a variable length code, such as a Huffman code, in accordance wth the quantization step supplied from the quantizer 332. The resulting converted quantization coefficients are outputted to a buffer not illustrated. The quantization coefficients and the quantization step are also supplied to an inverse quantizer 338 which dequantizes the quantization coefficients in accordance with the quantization step so as to convert the same to DCT coefficients. The DCT coefficients are supplied to the inverse DCT unit 340 which performs inverse DCT on the DCT coefficients. The obtained inverse DCT coefficients are then supplied to the arithmetic unit 348.

The arithmetic unit 348 receives the inverse DCT coefficients from the inverse DCT unit 340 and the data from the motion compensator 324 depending on the location of switch 344. The arithmetic unit 348 sums the signal (prediction residuals) from the inverse DCT unit 340 to the predicted picture from the motion compensator 324 to locally decode the original picture. However, if the predition mode indicates intra-coding, the output of the inverse DCT unit 340 may be directly fed to the frame memory. The decoded picture obtained by the arithmetic unit 340 is sent to and stored in the frame memory so as to be used later as a reference picture for an inter-coded picture, forward predictive coded picture, backward predictive coded picture, or a bi-directional predictive coded picture.

The enhancement encoder 314 comprises a motion estimator 354, a motion compensator 356, a DCT circuit 368, a quantizer 370, a VLC unit 372, a bitrate controller 374, an inverse quantizer 376, an inverse DCT circuit 378, switches 366 and 382, subtractors 358 and 364, and adders 380 and 388. In addition, the enhancement encoder 314 may also include DC-offsets 360 and 384, adder 362 and subtractor 386. The operation of many of these components is similar to the operation of similar components in the base encoder 312 and will not be described in detail.

The output of the arithmetic unit 340 is also supplied to the upsampler 350 which generally reconstructs the filtered out resolution from the decoded video stream and provides a video data stream having substantially the same resolution as the high-resolution input. However, because of the filtering and losses resulting from the compression and decompression, certain errors are present in the reconstructed stream. The errors are determined in the subtraction unit 358 by subtracting the reconstructed high-resolution stream from the original, unmodified high resolution stream.

The original unmodified high-resolution stream is also provided to the motion estimator 354. The reconstructed high-resolution stream is also provided to an adder 388 which adds the output from the inverse DCT 378 (possibly modified by the output of the motion compensator 356 depending on the position of the switch 382). The output of the adder 388 is supplied to the motion estimator 354. As a result, the motion estimation is performed on the upscaled base layer plus the enhancement layer instead of the residual difference between the original high-resolution stream and the reconstructed high-resolution stream. This leads to a perceptually better picture quality especially for consumer applications which have lower bit rates than professional applications.

Furthermore, a DC-offset operation followed by a clipping operation can be introduced into the enhancement encoder 314, wherein the DC-offset value 360 is added by adder 362 to the residual signal output from the subtraction unit 358. This optional DC-offset and clipping operation allows the use of existing standards, e.g., MPEG, for the enhancement encoder where the pixel values are in a predetermined range, e.g., 0 . . . . 255. The residual signal is normally concentrated around zero. By adding a DC-offset value 360, the concentration of samples can be shifted to the middle of the range, e.g., 128 for 8 bit video samples. The advantage of this addition is that the standard components of the encoder for the enhancement layer can be used and result in a cost efficient (re-use of IP blocks) solution.

Returning to FIG. 1, the base and enhancement layers created by the layered encoder 102 are stored separately in the storage apparatus 104. When the user or a control system 105 decides that more space is needed in the storage apparatus 104, an enhancement layer can be selected from the stored video streams. While the control system 105 is illustrated as being part of the storage apparatus 104, it will be understood that the control system 105 can be located elsewhere in the system 100. The user can select the appropriate enhancement layer or the control system 105 can select the enhancement layer based on previously entered criteria. The selected enhancement layer is read out of the storage apparatus and sent to the variable length decoder 106.

The variable length decoder 106 partially decodes the selected enhancement layer. For example, the variable length decoder may decode the DCT coefficients (AC and DC) of the selected enhancement layer. In this embodiment of the invention, the decoded DCT coefficients are attenuated by a predetermined constant value in the attenuator (multiplier unit) 108. The attenuation will have the effect of reducing the video resolution of the enhancement layer and reduces the bit-rate of the enhancement layer. The attenuated enhancement layer is then re-encoded by the variable length encoder 110 and the re-encoded enhancement layer is stored back in the storage apparatus 104.

If a DC-offset and clipping operation has been performed during the creation of the stored enhancement layer video data, as illustrated in FIG. 3 by elements 360 and 362, the DC-offset needs to be removed from the decoded enhancement layer video data prior to performing the attenuation step in the attenuator 108. In this embodiment as illustrated in FIG. 2, the corresponding DC-offset value 109 is removed from the DC DCT coefficient (first coefficient) of the decoded enhancement video data by a modification (subtraction) unit 111 prior to being supplied to the attenuator 108. After the attenuation step, the DC-offset value is added back into the DC DCT coefficient of the attenuated enhancement layer video data by a modification (addition) unit 113 prior to being supplied to the variable length encoder.

FIG. 4 illustrates a video compression and storage system 200 according to another embodiment of the invention. The system 200 is similar to the system 100 illustrated in FIG. 1 and like reference numerals have been used for like elements. In this embodiment, the attenuator 202 is comprised of a weighting means 204 and a quantizer 206. As in FIG. 1, the layered encoder 102 produces a base layer video stream and an enhancement layer video stream which are stored in the storage apparatus 104. When the user or the control system 105 selects an enhancement layer for reduction, the selected enhancement layer is read out of the storage apparatus 104 and partially decoded by the variable length decoder 106. The attenuator 202 performs a weighting step and a quantization step on the decoded DCT coefficients of the enhancement layer. The weighting step is performed by multiplying a 8*8 weighting matrix to blocks of DCT coefficients, each DCT coefficient being thus multiplied by a weighting factor contained in the matrix. The result of the multiplication is rounded to the nearest integer, wherein the weighting matrix is filled with values which amplitude are between 0 and 1, set for example to non-uniform values close to 1 for low frequential values and close to 0 for high frequential values, or to uniform values so that all coefficients in the 8*8 DCT block are equally attenuated. In other words, higher frequency coefficients are more attenuated than low frequency coefficients. The weighted DCT coefficients are then quantized by dividing the weighted DCT coefficients by a quantization factor for producing quantized DCT coefficients. The quantized DCT coefficients are then re-encoded by the variable length encoder 110 are stored back in the storage apparatus 104. In this embodiment, while the bit-rate of the enhancement layer is reduced, error propagation will occur and the coding-efficiency of the reduced enhancement layer will be reduced.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising ’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for providing elastic storage of layered video data stored in a storage apparatus, comprising the steps of:
reading stored enhancement layer video data out of said storage apparatus;
at least partially decoding the enhancement layer video data;
attenuating the decoded enhancement layer video data;
encoding the attenuated enhancement layer video data;
storing the encoded attenuated video data in said storage apparatus.

2. The method according to claim 1, wherein the attenuation reduces the bit-rate of the video data.

3. The method according to claim 1, wherein DCT coefficients of the decoded enhancement layer video data are attenuated.

4. The method according to claim 3, wherein the DCT coefficients are attenuated by a predetermined constant value.

5. The method according to claim 3, wherein the DCT coefficients are attenuated in a non-linear manner.

6. The method according to claim 4, wherein each DCT coefficient is multiplied by a weighting factor in a weighting matrix.

7. The method according to claim 6, wherein higher frequency coefficients are more attenuated than low frequency coefficients.

8. The method according to claim 6, wherein the weighted DCT coefficients are quantized by dividing the weighted DCT coefficients by a quantization factor prior to being re-encoded.

9. The method according to claim 1, further comprising the steps of:
removing a DC-offset value from a DC DCT coefficient of the decoded enhancement layer video data prior to the attenuation step; and
adding the DC-offset value back into the DC DCT coefficient of the attenuated enhancement layer video data before the encoding step.

10. An apparatus for providing elastic storage of layered video data stored in a storage apparatus, comprising:
means for reading stored enhancement layer video data out of said storage apparatus;
decoding means for at least partially decoding the enhancement layer video data;
attenuation means for attenuating the decoded enhancement layer video data;
encoding means for encoding the attenuated enhancement layer video data;
means for storing the encoded attenuated video data in said storage apparatus.

11. The apparatus according to claim 10, wherein the attenuation reduces the bit-rate of the video data.

12. The apparatus according to claim 10, wherein DCT coefficients of the decoded enhancement layer video data are attenuated.

13. The apparatus according to claim 12, wherein the DCT coefficients are attenuated by a predetermined constant value.

14. The apparatus according to claim 12, wherein the DCT coefficients are attenuated in a non-linear manner.

15. The apparatus according to claim 13, further comprising:
weighting means for multiplying each coefficient by a weighting factor in a weighting matrix.

16. The apparatus according to claim 10, wherein higher frequency coefficients are more attenuated than low frequency coefficients.

17. The apparatus according to claim 15, further comprising:
a quantizer for quantizing the weighted DCT coefficients by dividing the weighted DCT coefficients by a quantization factor prior to being re-encoded.

18. The apparatus according to claim 10, further comprising:
means for removing a DC-offset value from a DC DCT coefficient of the decoded enhancement layer video data prior to the attenuation step; and
means for adding the DC-offset value back into the DC DCT coefficient of the attenuated enhancement layer video data before the encoding step.
